(19) United States
(12) Patent Application Publication
(10) Pub. No.: US 2026/0039756 A1
(43) Pub. Date: Feb. 5, 2026

(54) IMAGE FORMING APPARATUS

(71) Applicant: CANON KABUSHIKI KAISHA, Tokyo (JP)

(72) Inventor: HIROSHI KOYAMA, Tokyo (JP)

(21) Appl. No.: 19/287,945

(22) Filed: Aug. 1, 2025

(30) Foreign Application Priority Data
Aug. 5, 2024 (JP) 2024-128944

(51) Int. Cl. H04N 1/00

(52) U.S. Cl. CPC H04N 1/00496; H04N 1/00631; H04N 2201/0094

(57) ABSTRACT

An image forming apparatus includes an image former configured to form an image on a sheet, a discharge tray with a stacking area where the sheet on which the image has been formed is to be stacked, and an operation device, wherein a portion of the operation device overlaps with the stacking area when the image forming apparatus is viewed from above in a vertical direction; and wherein the operation device has a first area which overlaps with the stacking area and a second area which does not overlap with the stacking area, and a height of a bottom surface of the operation device in the vertical direction is higher in the first area than in the second area.

### BACKGROUND

### Field of the Technology

The present disclosure relates to an image forming apparatus, such as a printer, a copying machine, or a multifunction apparatus.

### Description of the Related Art

An image forming apparatus includes an operation unit as a user interface. The operation unit is equipped with input interfaces, such as various key buttons and a touch panel, and output interfaces, such as a display and a speaker. The operation unit is positioned at a location easily operated from an upper part and front part of a main body of the image forming apparatus in view of user operability. The display may be equipped with a mechanism that allows an angle of its display surface to be changed. In such operation units, the display parts tend to become larger due to an increase of information displayed thereon and adaption of touch panels.

The image forming apparatus has a space including a sheet stack surface for stacking a discharged sheet on which an image is printed, and this space is provided at a location where it is easy to access it from an upper part and front part of the main body of the image forming apparatus. Considering that the operation units tend to have larger sizes as describe above, it is required that the user operability and the accessibility to the discharged sheet should be reconciled. U.S. Pat. No. 9,527,692 discloses an image forming apparatus having a configuration that realizes both operability and accessibility. In the image forming apparatus described in U.S. Pat. No. 9,527,692, an operation unit is arranged above a discharge space of a sheet, and a sheet is discharged from a back side to a front side of an apparatus main body. In a display of the operation unit, an angle of its display surface can be changed. The maximum motion space of the display of the operation unit is located above a path of a discharged sheet to a discharge space of the sheet.

In order to suppress the reduction in sheet stacking performance while miniaturizing the size of the apparatus, further improvements can be made in the arrangement and shape of the operation unit.

### SUMMARY

An image forming apparatus according to at least one embodiment of the present disclosure includes an image former configured to form an image on a sheet, a discharge tray with a stacking area where the sheet on which the image has been formed is to be stacked, and an operation device, wherein a portion of the operation device overlaps with the stacking area when the image forming apparatus is viewed from above in a vertical direction; and wherein the operation device has a first area which overlaps with the stacking area and a second area which does not overlap with the stacking area, and a height of a bottom surface of the operation device in the vertical direction is higher in the first area than in the second area.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming apparatus.

FIG. 2 is a configuration diagram of the image forming apparatus.

FIG. 3 is a configuration diagram of the image forming apparatus.

FIG. 4 is a configuration diagram of the image forming apparatus.

FIG. 5 is a configuration diagram of the image forming apparatus.

FIG. 6 is a configuration diagram of the image forming apparatus.

FIG. 7 is a configuration diagram of the image forming apparatus.

FIG. 8 is a configuration diagram of the image forming apparatus.

### DESCRIPTION OF THE EMBODIMENTS

Now, description is given of at least one embodiment of the present disclosure with reference to the accompanying drawings. However, the dimensions, materials, shapes, relative arrangements, etc., of components described in the following embodiments should be appropriately modified according to a configuration of an apparatus to which the present disclosure is applied and various conditions, thus, the scope of the present disclosure should not be limited to the description.

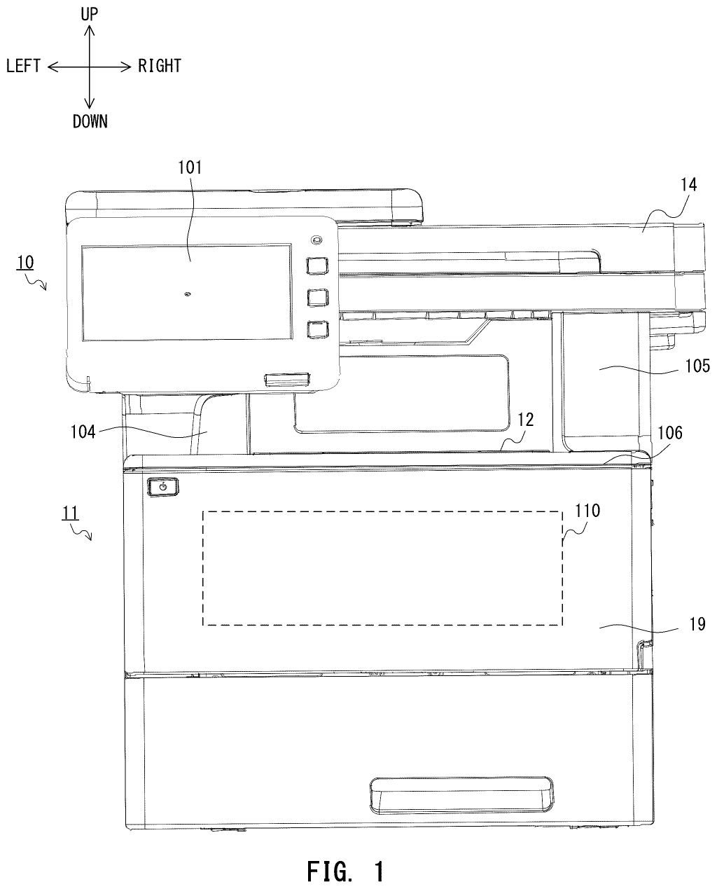

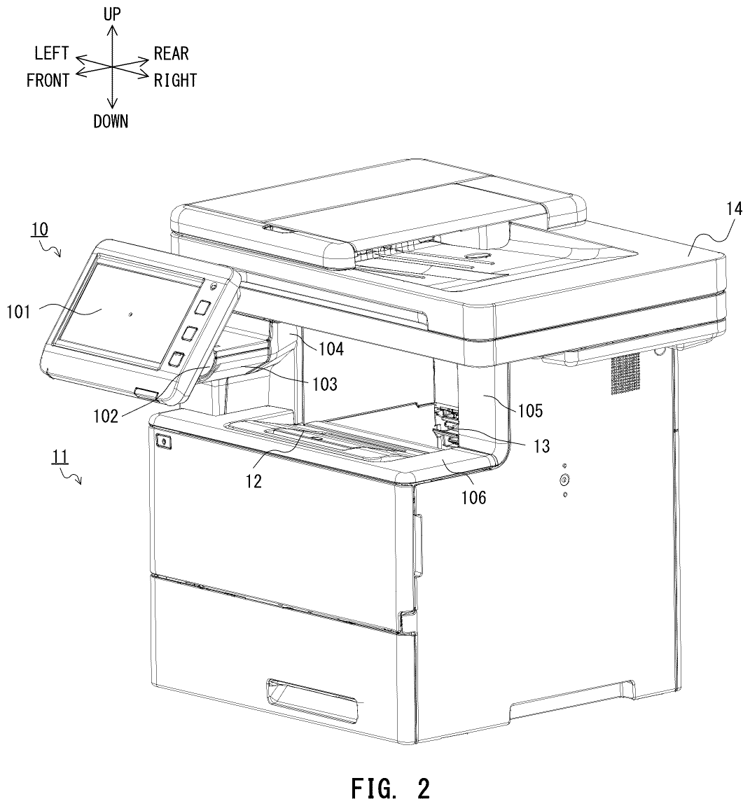

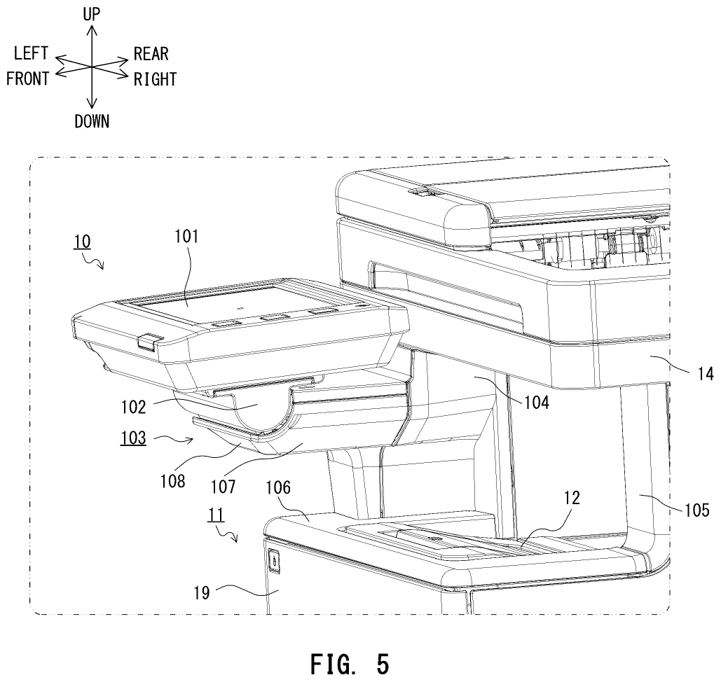

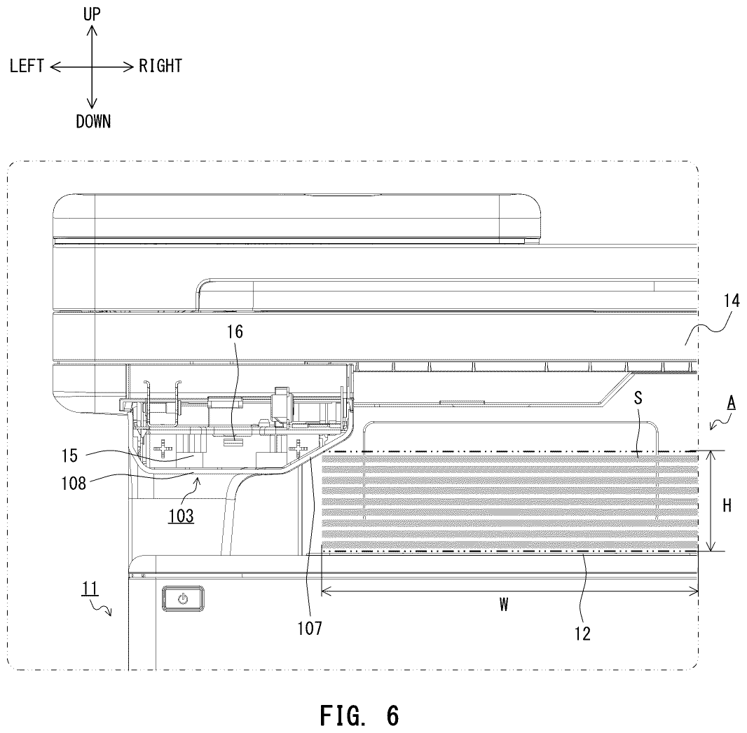

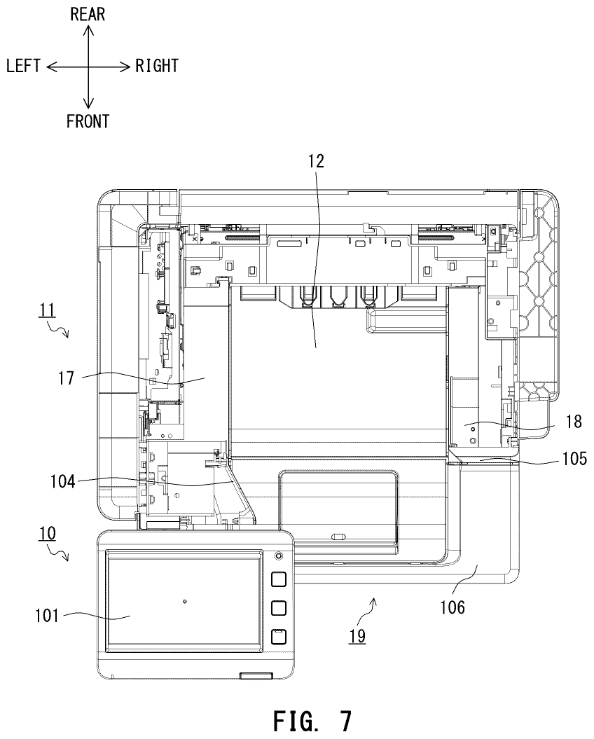

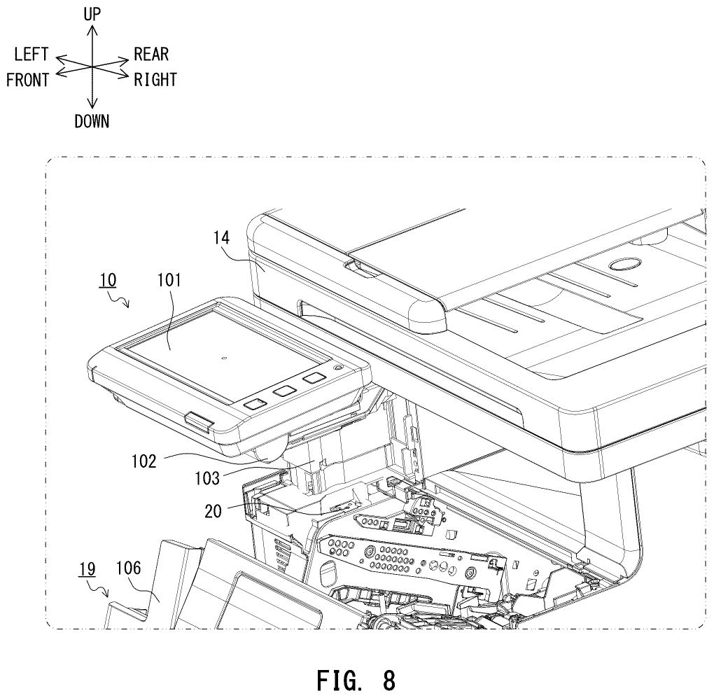

FIGS. 1-8 are configuration diagrams of an image forming apparatus according to the at least one embodiment. FIG. 1 is a front view of the image forming apparatus. FIGS. 2-4 are perspective views of the image forming apparatus as viewed from various directions. FIG. 5 is an expansion perspective view of an operation unit portion. FIG. 6 is a cross-sectional view of the image forming apparatus as viewed from the front. FIG. 7 is a top view of a main body of the image forming apparatus as viewed from the top in the vertical direction. FIG. 8 is an enlarged perspective view of the operation unit portion.

The image forming apparatus includes an image forming unit 110, which serves as an image former, to form an image on a sheet inside an apparatus main body 11. The image forming apparatus has an operation unit 10, which serves as an operation device, attached to an upper front side of the apparatus main body 11. The operation unit 10 is a user interface that includes input interfaces, such as various key buttons and a touch panel, and an output interfaces, such as a display 101 and a speaker. An image reading apparatus 14 to read images from a document is located at an upper portion of the apparatus main body 11. The apparatus main body 11 includes a discharge tray 12, a discharge portion 13, a main body first frame 17, a main body second frame 18, an opening/closing cover unit 19, and a board support plate 20. The image forming apparatus comprises an operation unit support portion cover 103 (hereinafter referred to as “support cover 103”), a main body first frame cover 104 (hereinafter referred to as “first frame cover 104”), a main body second frame cover 105 (hereinafter referred to as “second frame cover 105”), an opening/closing cover 106, and an inclined surface 107.

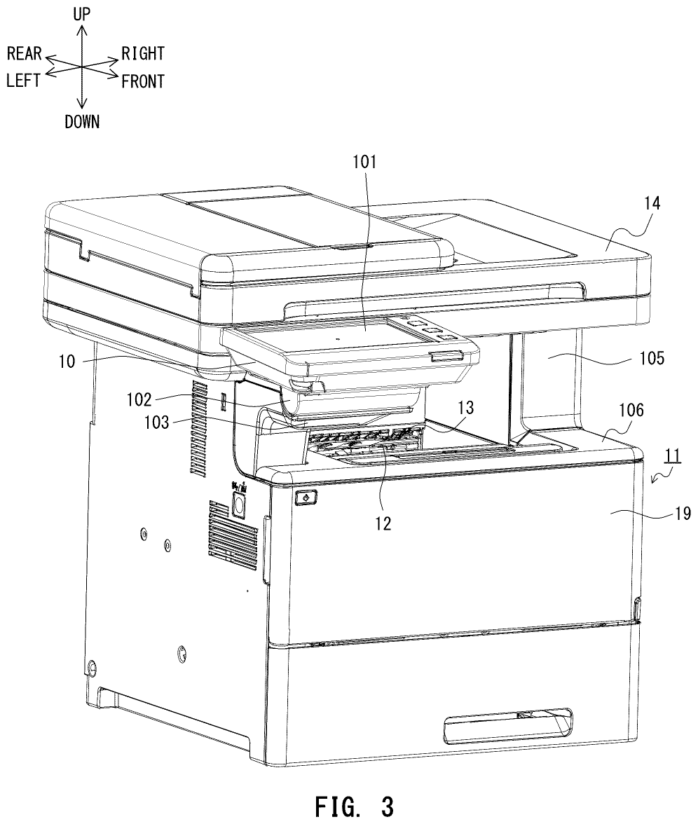

As shown in FIGS. 2 and 3, the sheet S on which an image has been printed by the image forming apparatus is discharged from the discharge portion 13 toward the front from the rear of the apparatus main body 11. The discharged sheet S is stacked on a sheet stacking surface of the discharge tray 12. The discharge tray 12 is provided in a discharge space between the upper end of the apparatus main body 11 and the image reading apparatus 14.

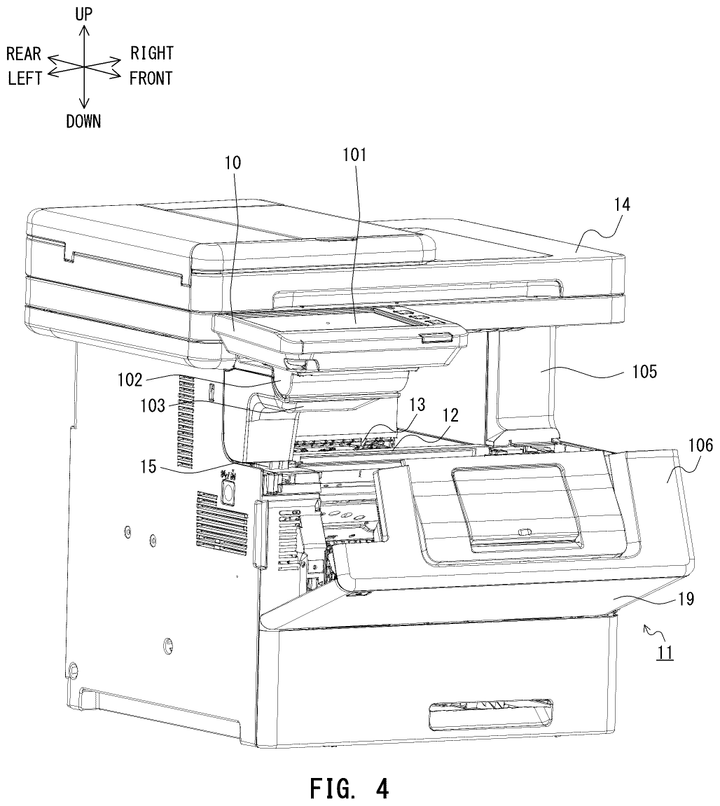

As shown in FIG. 4, the opening/closing cover unit 19 is mounted so as to be openable and closable relative to the apparatus main body 11 at a position at the upper end and front side of the apparatus main body 11. The opening/closing cover unit 19 is provided to allow access to internal units of the apparatus main body 11. Note that the opening/closing cover 106 is attached to the opening/closing cover unit 19.

As illustrated in FIGS. 5 and 6, the operation unit 10, which serves as an operation device, is arranged at a position above the apparatus main body 11 and also front side of the image reading apparatus 14. The operation unit 10 is supported, in an up-down direction, by an operation unit support portion 15 and an operation unit support plate 16. The support cover 103 is attached to the operation unit support portion 15. The operation unit 10 includes an operation unit hinge 102. The operation unit 10 is rotatable by the operation unit hinge 102, and a display surface of the display 101 can be adjusted to a predetermined angle. The movable range of the operation unit 10 is at least from an angle at which the display surface of the display 101 faces forward as shown in FIG. 1 to an angle at which it faces upward as shown in FIG. 3.

As shown in FIG. 6 and FIG. 1, when viewed from above in the vertical direction, a portion of the support cover 103 and the display 101 are arranged to overlap with the discharge tray 12 in a left-right direction of the apparatus main body 11. Hereinafter, the length in the up-down direction between the sheet stacking surface of the discharge tray 12 and a lower end of the support cover 103 is described as “maximum sheet stacking height H”. Sheets discharged onto the sheet stacking surface may curl. For this reason, the maximum sheet stacking height H is defined as a sum of a height of the sheets when the maximum number of sheets are stacked on the discharge tray 12 and the maximum curl height of the discharged sheet. The maximum curl height of the discharged sheet is the maximum value of the curl of the sheet, which is generated when the sheet is discharged onto the discharge tray 12, in the up-down direction, and varies depending on conditions such as the type of the sheet, temperature, and humidity. Thus, in the at least one embodiment, it is desirable to optimize sheet conveyance settings and image forming settings for each product so that the maximum curl height of the discharged sheet satisfies curl height specifications defined for each product.

Hereinafter, the maximum sheet size stacked on the sheet stacking surface of the discharge tray 12 is defined as “maximum sheet stacking width W”. Further, the area enclosed by the maximum sheet stacking height H and the maximum sheet stacking width W, i.e., discharge space, is defined as the maximum sheet stacking area A. It is difficult to miniaturize the entire image forming apparatus since the operation unit 10 is arranged above the apparatus main body 11 to prevent the operation unit 10 from interfering with a path of the sheet when discharged onto the sheet stacking surface. In the at least one embodiment, the entire image forming apparatus is miniaturized without interfering with the discharge of the sheets onto the sheet stacking surface.

As shown in FIG. 6, the support cover 103 has an inclined surface 107 at the lower end portion protruding in the horizontal direction toward the maximum sheet stacking area A. The inclined surface 107 serves as a sheet discharge guide and improves sheet stacking performance. The support cover 103 is formed so that a portion of the inclined surface 107 is located above the maximum sheet stacking area A. In other words, when viewed from above in the vertical direction, the operation unit 10 has a portion (first area) that overlaps with the maximum sheet stacking area A, and a portion (second area) that does not overlap with the maximum sheet stacking area A. The height, from the sheet stacking surface of a bottom surface of the operation unit 10 (or support cover 103) in the vertical direction, is higher in the first area than in the second area.

As shown in FIG. 7, the main body first frame 17 and the main body second frame 18 are positioned at the upper portion of the apparatus main body 11. The image reading apparatus 14 is supported at the upper portion of the apparatus main body 11 by the main body first frame 17 and the main body second frame 18. The image reading apparatus 14 is also supported by the operation unit support portion 15 and the operation unit support plate 16. The operation unit support portion 15, the operation unit support plate 16, and the main body first frame 17 support the image reading apparatus 14 at the left side of the discharge tray 12. The main body second frame 18 supports the image reading apparatus 14 at the right side of the discharge tray 12. The first frame cover 104 is attached to the main body first frame 17, and the second frame cover 105 is attached to the main body second frame 18.

As shown in FIG. 7, FIG. 2, and FIG. 3, the first frame cover 104, the second frame cover 105, and the opening/closing cover 106 are provided with inclined surfaces to improve accessibility to the sheet S discharged onto the discharge tray 12. As shown in FIG. 8, the board support plate 20 is disposed at a position at the upper end and also the left end of the apparatus main body 11, and is fixedly mounted to the apparatus main body 11.

### <Operation Unit Support Portion Cover>

As shown in FIG. 2, the sheet S on which an image is printed is discharged from the rear to the front of the apparatus main body 11 by the discharge portion 13 and is stacked on the discharge tray 12. As illustrated in FIG. 5, the operation unit 10 is arranged at a position above the apparatus main body 11 and front of the image reading apparatus 14. The operation unit 10 is supported by the operation unit support portion 15 and the operation unit support plate 16 (see FIG. 6).

As shown in FIG. 6 and FIG. 1, a portion of the support cover 103 and the display 101 of the operation unit 10 are arranged to overlap with the discharge tray 12 in the horizontal direction. The support cover 103 has an inclined surface 107, at the lower end portion protruding toward the maximum sheet stacking area A, to serve as a sheet conveyance guide. The inclined surface 107 is provided above the maximum sheet stacking area A. With this configuration, the support cover 103 does not interfere with the path of the discharged sheet S and does not affect the sheet stacking performance.

The inclined surface 107 of the support cover 103 is explained.

As shown in FIG. 6, the support cover 103 is provided such that a part (right side: first area) overlaps with the maximum sheet stacking area A in the horizontal direction, and the other part (left side: second area) excluding the part is provided in an area outside the maximum sheet stacking area A. The inclined surface 107 is provided on a side of a portion (first area side) of the support cover 103 which overlaps with the maximum sheet stacking area A. The other portion (second area) of the support cover 103 is a lower portion 108 which is parallel to the sheet stacking surface of the discharge tray 12. The support cover 103 is configured such that a length in the up-down direction at a side of the inclined surface 107 is shorter than a length in the up-down direction at a side of the lower portion 108. In other words, the first area is located at a higher position in the vertical direction than the second area, and the distance between the first area and the sheet stacking surface is longer than the distance between the second area and the sheet stacking surface. The inclined surface 107 is inclined so that the length in the up-down direction between the inclined surface 107 and the sheet stacking surface becomes shorter as it approaches the side of the maximum sheet stacking area A, i.e. toward the tip thereof. The lower portion 108 has a flat surface shape on the side facing the sheet stacking surface and is configured so that the length in the left-right direction is longer than half the horizontal length of the support cover 103.

In this way, in a case where a part of the support cover 103 and the display 101 of the operation unit 10 overlap, in the horizontal direction, with the discharge tray 12, an inclined surface 107 is positioned at the overlapping portion. This suppresses deterioration of the sheet stacking performance of the discharged sheet S. In addition, the inclined surface 107 serves as a conveyance guide for the sheet S to be discharged. With this configuration, it is possible to arrange the operation unit 10 lower than the path of the discharged sheet S. Thus, it is not necessary to make the operation unit 10 and the support cover 103 to be large in the upper portion of the apparatus main body 11. In addition, it is possible to minimize the size in the up-down direction from the lower end of the apparatus main body 11 to the upper end of the operation unit 10 or the image reading apparatus 14.

The image reading apparatus 14 provided in the image forming apparatus is an optional device and may not be installed. In an image forming apparatus that is not equipped with the image reading apparatus 14 may not have the main body first frame 17 and the main body second frame 18 in the apparatus main body 11. The operation unit 10 is disposed above the apparatus main body 11 and is supported, as to the up-down direction of the apparatus main body 11, by the operation unit support portion 15 and the operation unit support plate 16. The inclined surface 107 of the support cover 103 is described as above.

In the at least one embodiment, the path of the discharged sheet is protected by the inclined surface 107, however, the shape of the support cover 103 is not limited to this. For example, the support cover 103 may be formed, instead of the inclined surface 107, in a crank shape for avoiding interference with the maximum sheet stacking area A. Even when the inclined surface 107 is formed in the crank shape instead of the inclined surface, the path of the sheet during discharge is ensured. Thus, it is not necessary to make the operation unit 10 and the support cover 103 to be large in the upper portion of the apparatus main body 11. In addition, it is possible to minimize the size in the up-down direction from the lower end of the apparatus main body 11 to the upper end of the operation unit 10 or the image reading apparatus 14.

According to the present disclosure, decrease in the sheet stacking performance due to the operation unit can be suppressed. Further, according to the present disclosure, there is provided an image forming apparatus in which the reduction in the sheet stacking performance due to the operation unit is suppressed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-128944, filed Aug. 5, 2024, which is hereby incorporated by reference herein in its entirety.

What is claimed is:

1. An image forming apparatus, comprising:
an image former configured to form an image on a sheet;
a discharge tray with a stacking area where the sheet on which the image has been formed is to be stacked; and
an operation device,
wherein a portion of the operation device overlaps with the stacking area when the image forming apparatus is viewed from above in a vertical direction; and
wherein the operation device has a first area which overlaps with the stacking area and a second area which does not overlap with the stacking area, and a height of a bottom surface of the operation device in the vertical direction is higher in the first area than in the second area.

2. The image forming apparatus according to claim 1, further comprising:
a support portion configured to support the operation device; and
a support portion cover attached to the support portion,
wherein the support portion cover comprises a first portion which overlaps with the stacking area and a second portion which does not overlap with the stacking area, and a length of the first portion in the vertical direction is shorter than a length of the second portion in the vertical direction.

3. The image forming apparatus according to claim 2,
wherein the support portion cover comprises an inclined surface in the first portion.

4. The image forming apparatus according to claim 3,
wherein the inclined surface is inclined so that a length in an up-down direction becomes shorter toward the chip thereof.

5. The image forming apparatus according to claim 2,
wherein the second portion of the support portion cover comprises a flat-shaped side which faces a surface of the discharge tray on which the sheet is to be stacked.

6. The image forming apparatus according to claim 5,
wherein the second portion of the support portion cover is parallel to the surface of the discharge tray on which the sheet is to be stacked.

7. The image forming apparatus according to claim 6,
wherein the length of the second portion of the support portion cover is longer than half a horizontal length of the support portion cover.

8. The image forming apparatus according to claim 1, further comprising,
a discharge portion configured to stack the sheet on which image has been formed by the image former on the discharge tray by discharging the sheet toward front from rear of the image forming apparatus.

9. The image forming apparatus according to claim 1,
wherein an image reading apparatus configured to read an image from a document is provided at a position above the stacking area in the vertical direction.
